(19) United States
(12) Patent Application Publication
(10) Pub. No.: US 2007/0024153 A1
(43) Pub. Date: Feb. 1, 2007

(54) Rotor for an electric machine with improved cooling, magnetic noise, and reduced inertia using profiled rotor pole fingers

(76) Inventor: Michael T. York, Pendleton, IN (US)

Correspondence Address: CANTOR COLBURN, LLP, 55 GRIFFIN ROAD SOUTH, BLOOMFIELD, CT, 06002, US

(21) Appl. No.: 11/192,349

(22) Filed: Jul. 28, 2005

(51) Int. Cl. H02K 1/22

(52) U.S. Cl. 310/263

(57) ABSTRACT

A rotor assembly for an electric machine, which includes a shaft; a core positioned on the shaft; a field winding surrounding the core; a plurality of pole fingers configured to rotate with the shaft; the plurality of pole fingers each having a tip end, a root end, a straight trailing edge, and a curved leading edge; wherein the tip end is offset from the root end in a trailing direction with respect to rotation.

### TECHNICAL FIELD

The application relates generally to an electrical apparatus. More specifically, this application relates to a rotor for an electric machine having improved cooling and reduced magnetic noise.

### BACKGROUND OF THE INVENTION

Electric machines are found in virtually every motor vehicle manufactured today. These electric machines, also referred to as alternators, produce electricity necessary to power vehicle electrical accessories, as well as to charge a vehicle's battery. Electric machines must also provide the capability to produce electricity in sufficient quantities to power a vehicle's electrical system in a manner that is compatible with the vehicle electrical components. Furthermore, electrical loads for vehicles continue to escalate while, at the same time, the overall package size available for the electrical machine continues to shrink. Consequently, there is a continuing need for a higher power-density system.

An electric machine typically includes a stationary winding called a stator and a rotating field winding, including two pole segments, called a rotor. Currently, alternator stator wires within high power-density machines operate around the maximum limitation of the wire and stator slot linear insulation capability. The requirement for increased power-density machines is driving the need to improve the stator wire cooling capability. However, in the new higher power-density alternators like the Remy S-series and the Remy S-series, the end-turn height of the wires extending beyond the stator core is much shorter than conventional machines, even though the rotor length is substantially equivalent to conventional machines. This results in the fans on a dual internal fan alternator not being aligned with the stator wire end turns. Therefore, the airflow from the fans does not completely cover the stator wire end-turns, resulting in a lost opportunity to cool the wires.

Additionally, the conventional electric machine designs are known to produce a significant amount of magnetic noise while being operated. Electric machine noise reduction promotes quieter automobile interiors and thus, due to customer demands, enhances the commercial value of the automobile.

### BRIEF SUMMARY OF THE INVENTION

In one embodiment, a rotor assembly for an electric machine includes a shaft; a core positioned on the shaft; a field winding surrounding the core; a plurality of pole fingers configured to rotate with the shaft, the plurality of pole fingers each having a tip end, a root end, a substantially straight trailing edge, and a curved leading edge; wherein the tip end is offset from the root end in a trailing direction with respect to rotation direction.

In another embodiment, a rotor assembly for an electric machine is disclosed which includes a shaft; a pole segment positioned on the shaft; a field winding surrounding the core; a plurality of pole fingers configured to rotate with the shaft, the plurality of pole fingers each having a tip end, a root end, a trailing edge side, and a leading edge side; wherein the root end has an inclined plane surface creating a void with an open end on the leading edge side.

In a yet another embodiment, a method to provide cooling to a plurality of stator wire end turns of an electric machine is disclosed. The method comprising: rotating a rotor assembly of the electric machine; configuring an inclined plane surface on a root end of a rotor pole finger; wherein the inclined plane surface directs air radially outward causing air to flow over the stator wire end turns.

### BRIEF DESCRIPTION OF THE DRAWINGS

Referring to the exemplary drawings wherein like elements are numbered alike in the accompanying Figures:

FIG. 1 is a top plan view of a rotor assembly;

FIG. 2 is a side view of a pole segment of FIG. 1;

FIG. 3 is an enlarged view of an individual pole finger of FIG.2; and,

FIG. 4 is a cross sectional view of an alternator with conventional stator windings.

FIG. 5 is a side view of a stator assembly.

FIG. 6 is a cross-sectional view of the stator assembly of FIG. 5.

### DETAILED DESCRIPTION OF THE INVENTION

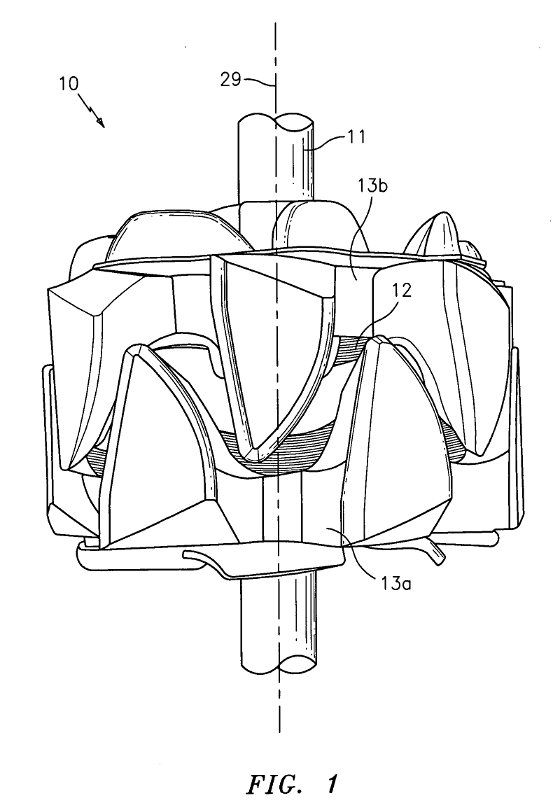

Referring to FIG. 1, an exemplary embodiment of a rotor assembly 10 for an electric machine that, for example, can be used in an automobile is illustrated. The rotor assembly 10 contains several basic components including a shaft 11, a field winding 12 surrounding a core (not shown), and a set of pole segments 13a and 13b. The shaft 11 serves as a mounting surface for these components and defines a central axis 29 about which the rotor assembly 10 rotates. The core may be a part of the shaft 11 or mounted to it. The field windings 12 are wound over the core which, when energized, create a magnetic field that saturates the surrounding pole segments 13a and 13b. The set of pole segments 13a and 13b are secured to the shaft 11 and oriented such that the pole segments 13a and 13b are opposed to each other and interdigitated as illustrated in FIG. 1.

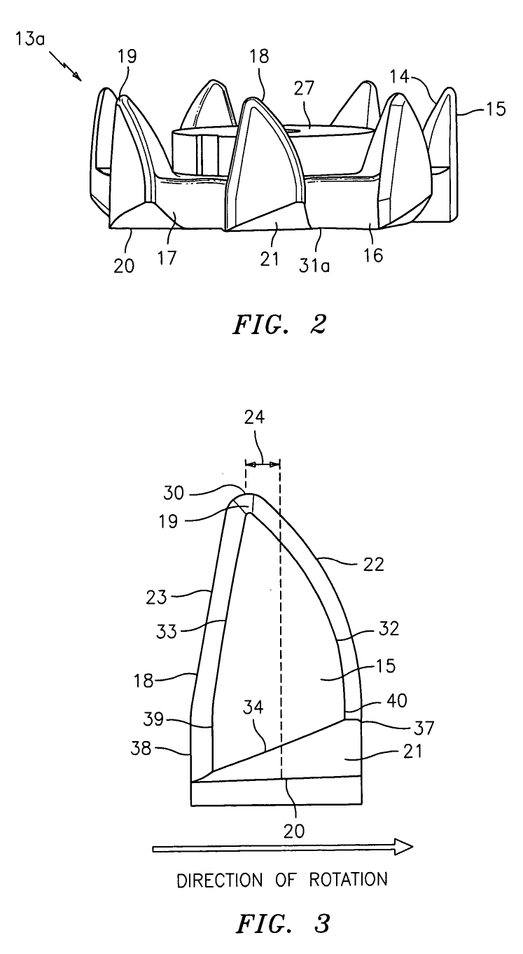

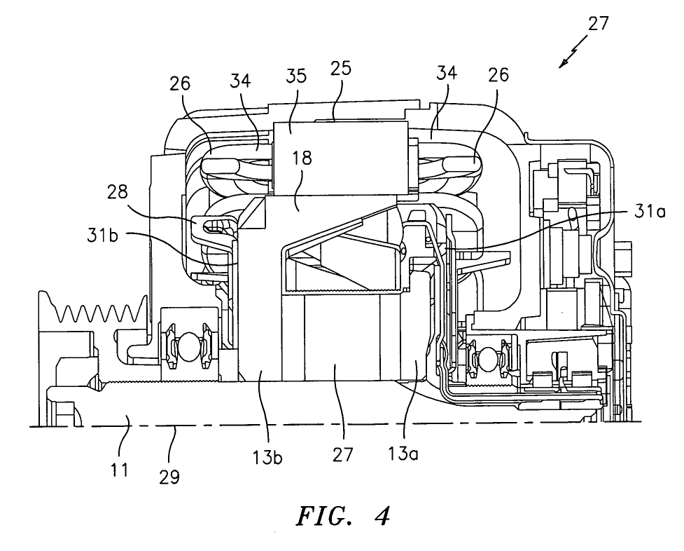

A plurality of pole fingers 18 are secured integrally on a periphery of each of the pole segments 13a and 13b as shown in FIG. 2. A profile shape of the individual pole fingers 18 is better illustrated in FIG. 3, which depicts an enlarged view of one of the pole fingers 18 and its features. The profile shape is characterized by a curved leading edge 22 and a substantially straight trailing edge 23. Furthermore, the axial centerline of a tip end 19 is offset from the axial centerline of a root end 20 in a trailing direction with respect to rotation, wherein the curved leading edge 22 extends beyond the axial centerline of the root end 20. The leading edge 22 may be made up of an arc or a plurality of arcs. The leading edge 22 intersects the trailing edge 23 at a radius edge 30 of the tip end 19 of the pole finger 18. The trailing edge 23 is skewed with respect to the central axis 29 such that the trailing edge 23 is not perpendicular to a pole segment 13a or 13b end plane 31a or 31b, wherein the pole segment 13a or 13b end plane 31a or 31b is perpendicular to the central axis 29, as shown in the accompanying figures. The orientation and shape of individual pole fingers 18 impacts the order of noise produced by the electrical machine. Harmonic frequencies associated with the rotational speed of the electrical machine's rotor can be manipulated by altering pole finger 18 geometry to reduce or change magnetic noise to more desirable tunes for the end user. Each of a tip end 19 to root end 20 offset 24, the curved leading edge 22 and the straight trailing edge 23 contribute to a pole finger 18 shape that reduces the amount of magnetic noise generated by the electric machine.

Further the disclosed pole finger 18 shape allows for improved airflow and cooling to a plurality of stator wire end turns 26. An inclined plane surface 21 on the root end 20 of the pole finger 18 acts like a fan when rotor assembly 10 is rotating to provide cooling and improved airflow. The inclined plane 21 forms a void on the root end 20 of the pole finger 18 and is oriented such that the open end of the void is on a leading edge side 17 of the pole finger 18. As the rotor assembly 10 rotates, air enters the void area created by the inclined plane surface 21 on the leading edge side 17 and the air is redirected as the void area narrows to a closed end on a trailing edge side 16. The redirection of the air, blows the air out in a radial direction as the rotor assembly 10 rotates. The inclined plane surfaces 21 are oriented at the same axial location, with respect to the shaft 11, and radially inward from, and in close proximity with, the stator wire end turns 26. The inclined plane surface 21 allows the root end 20 of the pole fingers 18 to redirect airflow and improve cooling to the stator wire end turns 26 and the electric machine.

An outside face 15 of each of the individual pole fingers 18 is bounded and defined by the disclosed pole finger shape. The outside face 15 is characterized by an arc 32, or a plurality of arcs, at the intersection of the outside face and the curved leading edge, a substantially straight line 33 at the intersection of the outside face and the substantially straight trailing edge, and an angled line 34 at the intersection of the outside face and the inclined plane surface 21.

The disclosed pole finger shape also provides for mass reduction of the individual pole fingers 18, and therefore the pole segments 13a and 13b and the rotor assembly 10. The inclined plane surface 21 allows for the added functionality of mass reduction due to the void formed by the incline plane surface 21. Conventional pole fingers do not typically have an inclined plane at the root end but rather have root ends that are uniform and symmetric with substantially trapezoidal geometry. The intersecting leading edge 22 and trailing edge 23, at a radius edge 30, also reduces mass at the tip end 19 by minimizing the width of the tip end 19. Conventional pole fingers have a tip end that forms a straight edge, between the leading edge and trailing edge, perpendicular to the central axis 29. The intersecting leading edge 22 and trailing edge 23, at a radius edge 30, in the present disclosure results in reduced mass as compared to the conventional straight tip end based on the difference in cross-sectional areas and volumes. Yet another feature that results in reduced mass is the narrowing of the pole fingers 18 in cross-sectional area from the root end 20 to the tip end 19 in such a manner that an inside face 14 of the pole finger 18 tapers from the root end 20 to the tip end 19 such that the outside face 15 maintains its cylindrical shape while the inside face 14 tapers from the root end 20 to the tip end 19 thus reducing cross-sectional area and mass in the direction approaching the pole finger 18 tip end 19. This reduction in mass results in several benefits, including that the overall mass of the rotor assembly 10 is decreased, which in turn decreases the rotational inertia of the rotor assembly 10. This decrease in rotational inertia allows the rotor assembly 10 to be more easily started and stopped, as well as providing for reduced belt wear and the need for implementing expensive over-running pulleys. Furthermore, the reduction of mass reduces pole finger 18 deflection at high rotation speeds. This reduction in centrifugal deflection of the pole finger 18 increases the maximum speed capability of the alternator and its rotor assembly 10. Reduced deflection also allows for maintaining a smaller air gap between the rotor assembly 10 and stator 25 and thus increases the output of the electric machine.

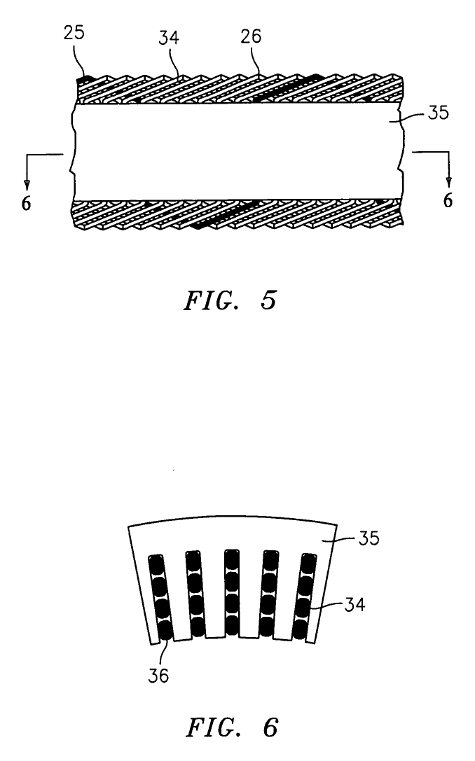

The stator, having a stator frame 35 and a plurality of stator windings, or stator wires 34, is further illustrated in FIGS. 5 and 6. The stator frame 35 has a plurality of radial slots 36 having an opening along the inner periphery of the stator frame 35. The stator wires 34, which are inserted into the radial slots 36, are insulated wires and may be of round, rectangular, or square wire construction.

The rotor assembly 10, pole segments 13a and 13b, and individual pole fingers 18 described in this disclosure are not limited to three phase electric machines, as are typical in automotive alternators, but can be applied to any other poly-phase electric machine, such as a six-phase electric machine.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A rotor assembly for an electric machine comprising:
a shaft having a central axis;
a core positioned at the shaft;
a field winding in operable communication with the core; and
a plurality of pole fingers rotateable with the shaft, the plurality of pole fingers adjacent to and separate from the core, the plurality of pole fingers each having a tip end, a root end, a substantially straight trailing edge intersecting a substantially straight root end edge, and a curved leading edge intersecting another substantially straight root end edge; wherein the root end edges are substantially parallel to the central axis of the shaft and the tip end is offset from the root end in a trailing direction with respect to rotation direction.

2. The rotor assembly of claim 1 wherein the straight trailing edge is skewed with respect to the central axis of the rotor assembly.

3. The rotor assembly of claim 1 wherein the curved leading edge is made up of an arc or a plurality of arcs.

4. The rotor assembly of claim 1 wherein the curved leading edge intersects the straight trailing edge at a radius edge.

5. The rotor assembly of claim 1 further comprising an inside face wherein the inside face tapers down from the root end to the tip end.

6. The rotor assembly of claim 1 wherein the electric machine creates a six-phase alternating current voltage.

7. The rotor assembly of claim 1 further comprising a stator surrounding the rotor assembly wherein the stator contains substantially rectangular insulated wire.

8. The rotor assembly of claim 1 further comprising an outside face wherein the outside face geometry is bounded by an arc, a substantially straight line, and an angled line.

9. A rotor assembly for an electric machine comprising:
a shaft having a central axis;
a pole segment positioned at the shaft;
a field winding in operable communication with the pole segment; and
a plurality of pole fingers configured to rotate with the shaft, the plurality of pole fingers each having a tip end, a root end, a substantially straight trailing edge intersecting a substantially straight root end edge, and a curved leading edge intersecting another substantially straight root end edge, wherein the root end edges are substantially parallel to the central axis of the shaft and the root end has an inclined plane surface creating a void with an open end on the leading edge side.

10. The rotor assembly of claim 9 wherein the void has a closed end on the trailing edge side.

11. The rotor assembly of claim 9 wherein the inclined plane root end surface is a flat planar surface.

12. The rotor assembly of claim 9 wherein the inclined plane root end surface is a curved surface.

13. The rotor assembly of claim 9 wherein the electric machine creates a six-phase alternating current voltage.

14. The rotor assembly of claim 9 further comprising a stator surrounding the rotor assembly wherein the stator contains substantially rectangular insulated wire.

15. The rotor assembly of claim 9 further comprising an outside face wherein the outside face geometry is bounded by an arc, a substantially straight line, and an angled line.

16. A method to provide cooling to a plurality of stator wire end turns of an electric machine, the method comprising:
rotating a rotor assembly having a pole segment and a separate core;
configuring an inclined flat plane surface on a root end of a rotor pole finger extending from the pole segment, wherein the inclined flat plane surface directs air radially outward causing air to flow over the stator wire end turns.
